(19) United States
(12) Patent Application Publication
(10) Pub. No.: US 2021/0209627 A1
(43) Pub. Date: Jul. 8, 2021

(54) METHODS AND APPARATUS TO ESTIMATE MARKET OPPORTUNITIES FOR AN OBJECT CLASS

(71) Applicant: The Nielsen Company (US), LLC, New York, NY (US)

(72) Inventors: Alejandro Terrazas, Santa Cruz, CA (US); John Charles Torres, San Diego, CA (US); Wei Xie, Woodridge, IL (US); Jennifer A. Bukich, San Diego, CA (US); Peter Lipa, Tucson, AZ (US); Song Lin, San Diego, CA (US)

(21) Appl. No.: 17/149,470

(22) Filed: Jan. 14, 2021

Related U.S. Application Data
(63) Continuation of application No. 14/671,273, filed on Mar. 27, 2015, now abandoned.

(51) Int. Cl. G06Q 30/02

(52) U.S. Cl. CPC G06Q 30/0202; G06Q 30/0205

(57) ABSTRACT

Methods and apparatus to estimate market opportunities for an object class are disclosed. An example method includes obtaining first measurements of a set of characteristics for a first area, the set of characteristics being associated with an item class; determining a first relationship between a first probability of a population in the first area to purchase the item class and the first measurements of the set of characteristics; obtaining second measurements of the set of characteristics for a second area; and estimating a second probability of a population of the second area purchasing the item class based on applying the first relationship to the second measurements.

### RELATED APPLICATION

This patent arises from a continuation of U.S. patent application Ser. No. 14/671,273, which was filed Mar. 27, 2015, and is titled “METHODS AND APPARATUS TO ESTIMATE MARKET OPPORTUNITIES FOR AN OBJECT CLASS.” Priority to U.S. patent application Ser. No. 14/671,273 is claimed. U.S. patent application Ser. No. 14/671,273 is hereby incorporated herein by reference in its entirety.

### FIELD OF THE DISCLOSURE

This disclosure relates generally to commercial surveying, and, more particularly, to methods and apparatus to estimate market opportunities for an object class.

### BACKGROUND

Manufacturers and/or distributors of goods and/or services sometimes wish to determine where new markets are emerging and/or developing. Smaller, growing markets are often desirable targets for such studies. As these markets grow larger and/or mature, previous market research becomes obsolete and may be updated and/or performed again.

### BRIEF DESCRIPTION OF THE DRAWINGS

FIG. 1 is a block diagram of an example system constructed in accordance with the teachings of this disclosure to estimate a market opportunity for a specified item class in a geographic area.

FIG. 2 is a block diagram of an example implementation of the example measurement collector of FIG. 1.

FIG. 3 is an example aerial image that may be analyzed by the example measurement collector of FIGS. 1 and/or 2 to measure a characteristic of a geographic area.

FIG. 4 is an example ground level image that may be analyzed by the example measurement collector of FIGS. 1 and/or 2 to measure a characteristic of a geographic area.

FIG. 5 shows an example geographic area that may be searched by the example measurement collector of FIGS. 1 and/or 2 to measure activities as a characteristic of the geographic area.

FIG. 6 is a table of example economic information that may be collected and analyzed by the example measurement collector of FIGS. 1 and/or 2 to measure sales information as a characteristic of a geographic area.

FIG. 7 is a table of example sales information that may be collected and analyzed by the example measurement collector of FIGS. 1 and/or 2 to measure sales information as a characteristic of a geographic area.

FIG. 8 is a block diagram of an example implementation of the example centricity modeler of FIG. 1.

FIGS. 9A and 9B are numerical and graphical representations of an example heat map of an estimated market opportunity for a specified item class for a geographic area, which is generated by the example centricity estimator of FIG. 1.

FIG. 10 is a flowchart representative of example machine readable instructions which may be executed to implement the example measurement collector of FIG. 1 to measure a market opportunity of an item class in a geographic area.

FIG. 11 is a flowchart representative of example machine readable instructions which may be executed to implement the example centricity modeler of FIG. 1 to collect measurements of a set of characteristics for a geographic area.

FIG. 12 is a flowchart representative of example machine readable instructions which may be executed to implement the example market opportunity determiner of FIG. 1 to determine a relationship between a probability of purchasing a first item class and collected measurements of a set of characteristics.

FIG. 13 is a block diagram of an example processor platform capable of executing the instructions of FIGS. 10, 11, and/or 12 to implement the example image analyzer, the example image comparator, and/or the example point/area of interest classifier of FIGS. 1, 2, and/or 8.

The figures are not to scale. Wherever appropriate, the same reference numbers will be used throughout the drawing(s) and accompanying written description to refer to the same or like parts.

### DETAILED DESCRIPTION

As used herein, the term “market opportunity” for a geographic area refers to a demand, interest, and/or propensity (e.g., likelihood) to purchase within the geographic area.

As used herein, the terms “item class” and “purchasable item” refer to a set of products and/or services that are included within a class description and that may be purchased or rented (e.g., at a physical point of purchase such as a store, and/or via an electronic purchasing platform such as an e-commerce web site). The class description of an item class may be as broad or as specific as desired. For example, an item class of “cars” may include cars having any body style, any make, and model, any model year, any color, any standard and/or optional features, new and/or used, any number of wheels (e.g., 2, 3, 4, or more wheels), and/or any other variations that may occur within the class description of “cars.” Furthermore, the class description need not be rigidly and/or literally applied to define an item class, and in some examples is flexible and/or colloquial as appropriate for a given implementation.

As used herein, the term “centricity” refers to a level of interest, orientation, and/or preference possessed by a population of an area with respect to an item class. For example, the centricity of a particular population in an area may be higher for an item class of “video games” than the centricity of another population of another area. Centricity may be a self-perpetuating phenomenon caused by, for example, the suitability of a particular geographic area for the item class and/or the attraction of people with a preference for an item class to a geographic area in which there is already a disproportionately high preference for the item class. In addition to items (e.g., products and/or services) within the item class, centricity further reflects items and/or behaviors determined to be related to the item class. For example, a “motorcycle” centricity may reflect a preference for motorcycles, as well as related products such as gasoline, helmets, and protective apparel.

As used herein, the term “demand” refers to the desire and willingness to pay a price for a specific good or service. Demand may refer to individual demand (e.g., by an individual person) and/or aggregate demand (e.g., demand by a population within a defined area).

Examples disclosed herein generate an indicator or classification of a market opportunity for a particular product or service class in a geographic area. To generate such an indicator, some disclosed examples gather data indicating behavior associated with the product or service of interest from multiple data sources. In some such examples, these data also include geospatial, or location-based, components. That is, the data are related to a particular location or area. Example data sources include databases of aerial and/or ground level images, activity databases, surveys, points of interest, databases of sales information, and/or databases of economic information, among others. In some examples, data sources are derived from the same greater geographic region as the geographic area(s) for which classification is desired, in a similar geographic region as the geographic area(s) for which classification is desired, and/or anywhere such data sources are available.

From image-based data sources, disclosed examples extract visually observable features such as the presence of identifiable objects. Some disclosed examples extract visually observable features from satellite imagery and extract visually observable features from digital photos such as Google Street View photos and/or other publicly available photos having geographic metadata. The presence and/or quantities of visually observable features are used as characteristics to describe the geographic areas in which the features are observed (or not observed). As used herein, the term “visually observable” is defined to mean capable of observation by a human within an image, such as an aerial image or ground-level image. For example, a feature may be visually observable in an image despite not being visually observable by a person without the aid of a device that converts information falling outside of human perception into information that is capable of human observation. An example of such information conversion may be features in an infrared image, which is an image generated by converting infrared information captured by an infrared camera into the visible light spectrum.

Disclosed examples merge the extracted features and other characteristics to create one or more predictive models describing relationships between the measured characteristics and a centricity for the item class. Disclosed examples estimate the centricities of unknown areas to purchase item class(es) (e.g., product(s) and/or service(s)) by applying the predictive model(s) (obtained from known areas) to measurements of characteristics obtained for the unknown areas (e.g., in the same way the measurements were performed to develop the predictive model). Some examples then output results of market opportunities for the item class (e.g., product or service). Example results include a “heat map” of market opportunities, patterns, and/or classifications that reflect estimated demand and/or interest for the item class.

As an example, an item class of interest may be motor-based devices such as boats, cars, and/or all-terrain vehicles. Features are obtained from aerial and/or ground level images and include an area of space, a number of jet-skis, a number of pickup trucks, and garage sizes, and distances to dirt trails. Features are also obtained from surveys and/or other data sources that include income levels and number of dependents. These features are determined for areas in which purchases or ownership of motor-based recreational devices are known, in which to determine the respective weights of the features including weights based on distance and/or location. These features are then determined for areas in which purchases or ownership of motor-based recreational devices are unknown, and a heat map is generated using the measured features and determined weights. The heat map may then be used for, for example, focusing marketing materials in areas having higher likelihoods of purchases and/or locating a seller of motor-based devices.

The geographic area for which a market opportunity is estimated may be any desired shape and/or measured in any desired units (e.g., metric units, imperial units, city blocks, etc.).

By modeling the relationships between an item class and other characteristics that indicate a propensity and/or an economic capacity to purchase items in the class, example methods and apparatus disclosed herein may be used to identify market opportunities for products and/or services within and/or associated with the item class without physically surveying or sampling the areas (e.g., without the cost of having humans in the area, or without having “boots on the ground”).

Some examples disclosed herein measure one or more characteristics of a geographic area using aerial (e.g., satellite) images. As used herein, the term “aerial image of interest” refers to aerial images that include a specified geographic area and/or to aerial images of areas associated with (e.g., nearby), but not including, the specified geographic area.

Examples disclosed herein detect some types of characteristics or features of a geographic area using computer vision techniques, which may be combined with and/or verified via manual identification. For example, a computer or other machine may be provided with examples of objects that are to be identified and/or counted in a set of images of a geographic area. Such examples may include typical aerial views of the objects and/or ground level views of the objects. As used herein, the term “aerial view” refers to a view that is completely or primarily overhead. Aerial viewing allows for the viewer not being directly above the object. As used herein the term “ground view” refers to a view that is at or near ground level such that the view of an object that is also on or near the ground is a completely or primarily lateral view. For example, an image taken by a person standing at or near ground level (e.g., on the ground, on a ladder, from a second-floor window of a building) would be considered a ground view image unless stated otherwise. An image taken by an aircraft or satellite passing over the area around the object would be considered an aerial view. Images of an object that are between aerial views and ground views (e.g., an image taken from a higher story of a building, images taken between a 30° angle and a 60° angle with respect to ground, etc.) that partially captures a profile of an object and partially captures an overhead view of the object may be considered either aerial views or ground views, depending on the recognizable features of the object that are captured in the image.

Computer vision is a technical field that involves processing digital images in ways that mimic human processing of images. Disclosed example methods and apparatus solve the technical problems of accurately categorizing and/or matching aerial images using combinations of computer vision techniques and/or other geospatial data. Disclosed example techniques use computer vision to solve the technical problem of efficiently processing large numbers of digital images to find an image that is considered to match according to spatially distributed sets of features within the image.

Disclosed example methods involve recognizing, using a first computer vision technique, a first quantity of a first type of object in a first image of a first area, where the first type of object is associated with an item class. The disclosed example methods further involve obtaining first measurements of a first set of characteristics for the first area, where the first set of characteristics are associated with the item class and include the first quantity of the first type of object recognized using the processor. The disclosed example methods further involve determining a first relationship between a first probability of a population in the first area to purchase the item class and the first measurements of the first set of characteristics. The disclosed example methods further involve recognizing, using at least one of the first computer vision technique or a second computer vision technique, a second quantity of the first type of object in a second image of a first area. The disclosed example methods further involve obtaining second measurements of a second set of characteristics for the second area, where the second set of characteristics include the second quantity of the first type of object. The disclosed example methods further involve estimating a second probability of a population of the second area purchasing the item class based on applying the first relationship to the second measurements.

In some example methods, determining the first relationship between the first probability and the first measurements includes determining a model describing the first probability as a function of position within the first area. In some examples, determining the first relationship between the first probability and the first measurements is based on sales information for the item class within the first area. In some examples, the first set of characteristics includes sales of the item class and sales of a second type of purchasable item that is not included within the item class. In some examples, obtaining the first measurements includes using the first computer vision technique to analyze the first image of the first area to count a number of instances of the item class within the first area, where the first image is an aerial image.

In some examples, obtaining the first measurements involves using the first computer vision technique to analyze the first image of the first area to count a number of instances of a first type of object within the first area, where the first image is a ground level image. In some examples, obtaining the first measurements includes searching for a first presence of an activity within the first area, where the activity is selected based on the item class.

In some example methods, obtaining the first measurements includes collecting at least one of real estate value information or population income information. In some examples, estimating the second probability includes estimating market opportunities within the second area based on the first relationship and the second measurements.

Some example methods further involve generating a map representing the market opportunities for locations within the second area. In some examples, the market opportunities correspond to respective subsections of the second area. In some examples, the market opportunities include at least one of demand for the item class or a probability that a given person in the second area purchases the item class. In some examples, determining the first relationship between the first probability and the first measurements includes determining a second relationship between the first measurements and a propensity to purchase the item class.

Some example methods further involve determining a third relationship between the first measurements and an economic capacity to purchase the item class, where the first relationship in based on the second relationship and the third relationship.

Disclosed example apparatus include a measurement collector, a centricity modeler, and a centricity estimator. The example measurement collector collects first measurements of a set of characteristics for a first area and collects second measurements of the set of characteristics for a second area, the set of characteristics being associated with a specified type of purchasable item. The example centricity modeler determines a first relationship between a first probability of a population in the first area to purchase the specified type of purchasable item and the first measurements of the set of characteristics. The example centricity estimator estimates a second probability that a population of the second area will purchase the specified type of purchasable item based on applying the first relationship to the second measurements.

In some examples, the centricity modeler includes a propensity modeler and a capacity modeler. The example propensity modeler generates a first model describing a second relationship between a first subset of the characteristics and sales of the purchasable item. The example capacity modeler generates a second model describing a third relationship between a second subset of the characteristics and sales of the purchasable item, where the first relationship is a weighted combination of the second and third relationships.

In some examples, the measurement collector includes an aerial image collector and aerial image analyzer. The example aerial image collector retrieves an aerial image based on the first area. The example aerial image analyzer determines whether an object is present within the aerial image using a computer vision technique, where the object is selected based on the purchasable item.

In some examples, the measurement collector includes a ground level image collector and a ground level image analyzer. The example ground level image collector to retrieve a ground level image based on the first area. The example ground level image analyzer to determine whether an object is present within the ground level image using a computer vision technique, the object being selected based on the purchasable item.

In some examples, the measurement collector includes a sales data collector to collect sales information for the specified type of purchasable item, where the first relationship is determined based on the sales information.

In some examples, the measurement collector includes an activity searcher to search for a first presence of an activity within the first area, where the activity is selected based on the specified type of purchasable item. In some such examples, the activity searcher is to search for a second presence of the activity within the second area, the first relationship being determined based on the first presence of the activity in the first area and the second probability being estimated based on the second presence of the activity in the second area.

In some examples, the measurement collector includes an economic data collector to collect economic data for the first area, where the first relationship being determined based on the economic data. In some such examples, the economic data collector is to collect at least one of real estate value information or population income information.

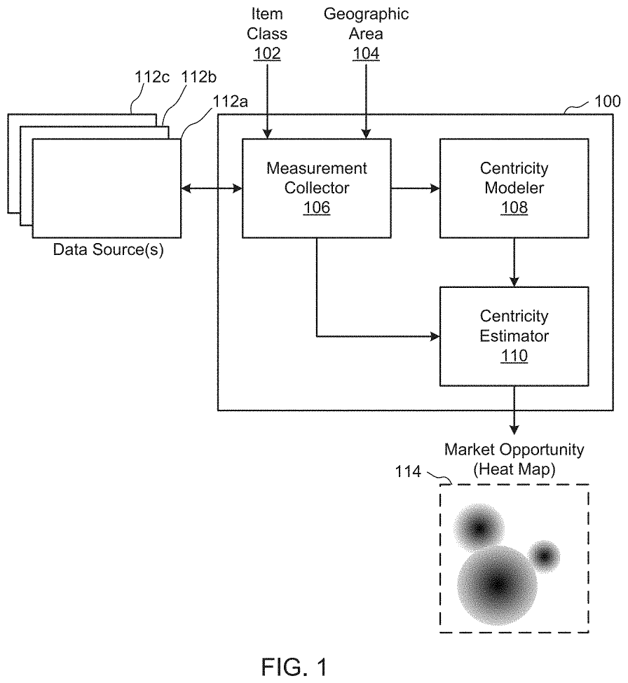

FIG. 1 is a block diagram of an example market opportunity determiner 100 to estimate a market opportunity for a specified type of purchasable item in a geographic area. Generally, the example market opportunity determiner 100 of FIG. 1 receives an identification of an item class 102 and an identification of a geographic area 104, measures characteristics of the geographic area 104, and estimates market opportunities for the item class 102 within the geographic area 104 using the measured characteristics and a relationship between the characteristics and a market opportunity. The example market opportunity determiner 100 of FIG. 1 includes a measurement collector 106, a centricity modeler 108, and a centricity estimator 110. The structure and operation of the example market opportunity determiner 100 are described in more detail below.

The example measurement collector 106 of FIG. 1 collects measurements of characteristics for geographic area(s), including area(s) from which a centricity model (e.g., a predictive model) is developed and area(s) in which the centricity model is to be applied (e.g., to determine a market opportunity). For example, during a model development phase the measurement collector 106 collects first measurements of a set of characteristics for a first area. Then, during a market opportunity evaluation phase the measurement collector 106 collects second measurements of the set of characteristics for a second area. The characteristics measured by the measurement collector 106 are selected based on an association between collectable data and the specified item class 102.

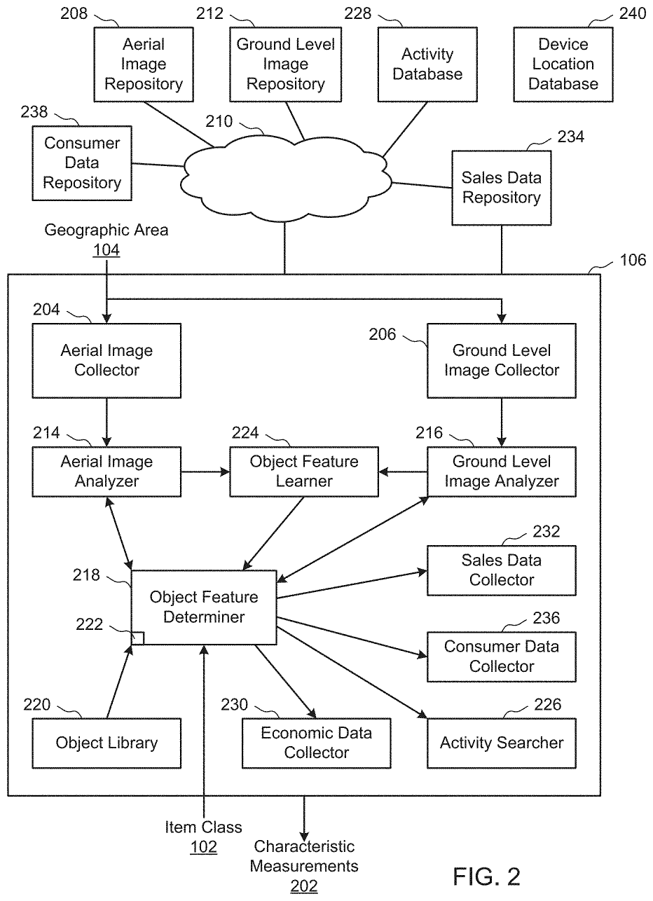

The example measurement collector 106 of FIG. 1 collects the measurements of the characteristics from one or more data sources 112a-112c. As described in more detail below, the example data sources 112a-112c may include aerial images, ground level images, surveys (e.g., electronic, personal, telephonic, etc.), economic data, activity data, and/or sales data, among other data sources. An example implementation of the measurement collector 106 is described below with reference to FIG. 2. The example measurement collector 106 may collect measurements from multiple areas in which the demand for the item class 102 is known. Multiple areas are then used to create and/or refine the centricity model (e.g., via the centricity modeler 108).

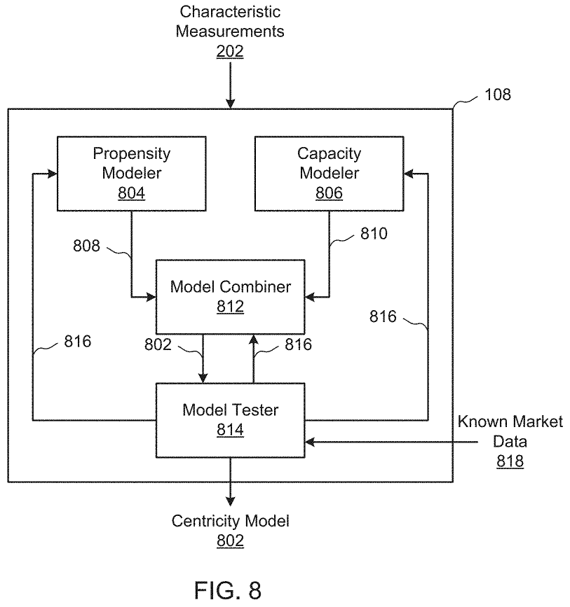

The example measurement collector 106 provides collected measurements of the characteristics to the centricity modeler 108. The example centricity modeler 108 of FIG. 1 determines a relationship between 1) a demand (e.g., a probability or likelihood of purchase by a population in the first area from which the measurement collector 106 collects measurements of the characteristics for generating the model) for products and/or services associated with the specified item class 102 and 2) the first measurements of the set of characteristics obtained from the measurement collector 106. In some examples, the centricity modeler 108 of FIG. 1 generates sub-models for different aspects of the relationship. For example, the centricity modeler 108 may generate a sub-model for each type of characteristic that is measured, and/or for combinations of the characteristics. The terms “likelihood” and “probability” are used interchangeably herein. An example implementation of the centricity modeler 108 is described below with reference to FIG. 8.

A first example sub-model is a propensity to purchase products and/or services associated with the specified item class 102 (e.g., the interest of the population in the specified item class 102). For example, a propensity-based sub-model describes probabilities that people are interested or willing to purchase products or services in the specified item class 102 (e.g., they have a preference for the item class 102). A propensity-based sub-model uses measured characteristics that reflect interests of the population of the geographic area 104.

A second example sub-model is a capacity to purchase products and/or services associated with the specified item class 102 (e.g., an economic capability to purchase the specified item class 102). For example, item classes that are more expensive to purchase (and/or require large quantities of purchases to enjoy) are often more sensitive to the economic conditions in an area than item classes that are less expensive to purchase (and/or do not require large quantities of purchases to enjoy). Therefore, while item classes 102 that are more expensive may benefit from the use of a capacity-based sub-model, other item classes 102 that are less expensive may rely more heavily, or even solely, on a propensity-based sub-model.

The example centricity estimator 110 of FIG. 1 obtains the centricity model from the centricity modeler 108. The centricity estimator 110 also obtains measurements of characteristics from the measurement collector 106 for an area that is to be analyzed (e.g., an area for which a market opportunity for the item class 102 is to be estimated). In the example of FIG. 1, the centricity estimator 110 obtains measurements for those characteristics that are modeled in the centricity model (e.g., non-modeled characteristics are irrelevant to the model and need not be collected).

The example centricity estimator 110 estimates a market opportunity 114 (e.g., a probability of purchase by a population of the second area) for a specified item class (e.g., product(s) and/or service(s) in the specified item class 102) by applying the centricity model to the second measurements. The result of the estimate is a geographically based set of purchase probabilities (or opportunity estimates, or demand estimates) that indicate a market opportunity for the specified item class 102. For example, the centricity estimator 110 may generate a heat map describing the probabilit(ies) for the geographic area being evaluated. The example market opportunity 114 (e.g., heat map) of FIG. 1 includes discrete values for sub-regions of the geographic area. Additionally or alternatively, the market opportunity 114 (e.g., heat map) may be expressed using one or more functions that may be used to calculate a probability or opportunity value for any selected location within the heat map.

FIG. 2 is a block diagram of an example implementation of the measurement collector 106 of FIG. 1. As mentioned above, the example measurement collector 106 receives an identification of an item class 102 and an indication of a geographic area 104. The example measurement collector 106 of FIG. 2 outputs characteristic measurements 202 (e.g., to the centricity modeler 108 and/or to the centricity estimator 110 of FIG. 1).

The example measurement collector 106 of FIG. 1 includes an aerial image collector 204 and a ground level image collector 206. As explained in more detail below, the example aerial image collector 204 collects aerial image(s) of the specified geographic area 104 and/or collects ground level image(s) taken within the specified geographic area 104. As used herein, the term “images” may refer to still images and/or images extracted from video.

From the indication of the geographic area 104, the example aerial image collector 204 identifies the location of the geographic area 104 and requests an aerial image of the geographic area 104 from an aerial image repository 208. For example, the aerial image collector 204 may interpret a text description of the geographic area 104 (e.g., a 5-digit zip code, a name of a municipality, country, or state, etc.) to a coordinate system (e.g., a set of GPS coordinates indicating a boundary or perimeter of an area) or other system used by the aerial image repository 208 to identify aerial images.

The example aerial image repository 208 of FIG. 2 provides aerial and/or satellite image(s) of specified geographic areas (e.g., the geographic area 104 and/or surrounding areas) to a requester that identifies those areas (e.g., via a network 210 such as the Internet). The example aerial images obtained by the aerial image collector 204 may include aerially generated images (e.g., images captured from an aircraft such as airplanes, helicopters, and/or drones, which may be operated by governments, commercial organizations, individuals, etc.), satellite-generated images (e.g., images captured from a satellite), and/or drone images (e.g., images captured using drone aircraft by governments, commercial organizations, individuals, etc.). The images may have any of multiple sizes and/or resolutions (e.g., images captured from various heights over the geographic areas). Example satellite and/or aerial image repositories that may be employed to implement the example aerial image repository 208 of FIG. 1 are available from DigitalGlobe®, GeoEye®, RapidEye, Spot Image®, and/or the U.S. National Aerial Photography Program (NAPP). The example aerial image repository 208 of the illustrated example may additionally or alternatively include geographic data such as digital map representations, source(s) of population information, building and/or other man-made object information, and/or external source(s) for parks, road classification, bodies of water, etc.

The geographic area 104 may be represented by one or more separate, individual images provided by the aerial image repository 208. The division of images may be based on the resolution of the images (e.g., whether the image at a particular level of zoom has sufficient detail to identify contextual features with sufficient accuracy).

The example aerial image collector 204 determines the scale and the relationships between the received image(s) (e.g., for use in determining distance). For example, the aerial image collector 204 may determine the pixel area and/or the scale from metadata associated with the image.

From the indication of the geographic area 104, the ground level image collector 206 obtains images from a ground level image repository 212. In some examples, the ground level image collector 206 queries the ground level image repository 212 using keywords associated with the specified item class 102, keywords associated with the specified geographic area 104, and/or metadata queries determined based on the geographic area 104. For example, the ground level image collector 206 may query the ground level image repository 212 for images taken within a particular time range, having metadata (e.g., location metadata such as Global Positioning System coordinates) that indicates that the images were obtained from within the geographic area 104, using keywords corresponding to the geographic area (e.g., street names, municipality names, landmark names, etc.), and/or images having a subject that is associated with the specified item class.

The example ground level image repository 212 of FIG. 2 provides ground level image(s) of specified geographic areas (e.g., the geographic area 104 and/or surrounding areas) to a requester that identifies those areas (e.g., via the network 210). The example ground level images obtained by the ground level image collector 206 may include street-level images (e.g., images automatically captured by a street-view camera, such as the Google Street View™ mapping service or other similar mapping services) and/or user-generated images (e.g., images automatically or manually captured by an individual and uploaded to an image hosting service such as the Flickr® photo hosting service, the Google+™ Photos photo sharing service, Photobucket® photo sharing service, and/or any other source of images). While the ground level image repository 212 is shown as a single entity in FIG. 2, the ground level image repository 212 may be implemented using any number of different sources and/or entities.

In an example in which the specified geographic area 104 is Schaumburg, Ill., United States, and the specified item class 102 is “recreational motor vehicles” (e.g., cars, passenger trucks, recreational vehicles, all-terrain vehicles, motorbikes, motorcycles, dune buggies, snowmobiles, go-karts, boats, personal watercraft, etc.), the example ground level image repository 212 may send one or more queries to the ground level image repository 212 that specifies the location “Schaumburg, Ill., United States,” and/or the equivalent range of GPS coordinates, and includes keywords that are predicted to provide an indication of the presence of the item class 102, such as “car,” “passenger truck,” “recreational vehicle,” “all-terrain vehicle,” “motorbike,” “motorcycle,” “dune buggy,” “snowmobile,” “go-karts,” “boats,” “personal watercraft,” “jet-ski,” “dealer,” “trail,” “marina,” “trailer,” “garage,” and/or other associated words and/or transformations of words. The example ground level image repository 212 returns the results of the quer(ies) to the ground level image collector 206.

The example measurement collector 106 of FIG. 2 further includes an aerial image analyzer 214. The example aerial image analyzer 214 uses computer vision to identify features from the aerial images obtained by the aerial image collector 204. The example aerial image analyzer 214 of FIG. 2 uses computer vision recognition techniques, such as the bag-of-words model for computer vision, to identify features or objects in the aerial images that are associated with the specified item class 102. For example, if the item class 102 is “boats” (or another item class to which boats are related), the example aerial image analyzer 214 may search for boats and/or bodies of water in the aerial images. However, the aerial image collector 204 may use other past, present, and/or future computer vision methods, and/or combinations of methods, to measure counts of objects in the aerial images. The use of computer vision to identify the contextual features increases the efficiency, increases the accuracy, and/or reduces the resources required to identify objects related to an item class 102 relative to some other computer vision techniques for object recognition.

The example measurement collector 106 of FIG. 2 further includes a ground level image analyzer 216. The example ground level image analyzer 216 analyzes ground level images obtained by the ground level image collector 206 to identify objects related to the item class 102. The example ground level image analyzer 216 may search ground level images using computer vision in a manner similar to the aerial image analyzer 214. However, the example ground level image analyzer 216 of FIG. 2 may additionally or alternatively search for different objects or features, use different computer vision techniques, and/or search for the same objects and/or features using the same computer vision techniques but using different object features than the aerial image analyzer 214.

For example, if searching the ground level images for a boat, the ground level image analyzer 216 searches for boat features such as a profile shape that would be observed from a ground level perspective (as opposed to a different shape that would likely be seen from an aerial perspective). The example ground level image analyzer 216 may additionally or alternatively search for boats in ground level images by searching for the presence of boat trailers on which the boats are resting, boats that are a distance from the ground (e.g., due to sitting on a trailer), boats in water, and/or other aspects that distinguish ground level views of boats from aerial views of boats.

The example aerial image analyzer 214 and the example ground level image analyzer 216 of FIG. 2 access features that are to be searched using an object feature determiner 218. The example object feature determiner 218 receives the indication of the item class 102 and accesses an object library 220 to determine object(s) that are associated with the item class 102. The object library 220 also includes descriptions of the objects in the object library 220. The descriptions of the objects enable the aerial image analyzer 214 and the ground level image analyzer 216 to visually analyze images to identify the objects.

The example object feature determiner 218 includes an association table 222 that defines relationships between item classes, objects, activities (e.g., physical activities and/or digital device-based activities), economic data, and/or any other information that is associated with an item class.

For example, the association table 222 of FIG. 2 associates concepts such as recreational motor vehicles, cars, passenger trucks, recreational vehicles, all-terrain vehicles, motorbikes, motorcycles, dune buggies, snowmobiles, go-karts, boats, personal watercraft, off-road trails, marinas, water, lakes, rivers, mechanics, repairs, parts stores, and dirt tracks, among others. When the object feature determiner 218 receives one of the listed related concepts as the identified item class 102, the object feature determiner 218 queries the association table 222 to obtain the other related concepts. The example object feature determiner 218 accesses the object library 220 to obtain the descriptions of the related concepts and the item class 102. The object feature determiner 218 provides the descriptions to the aerial image analyzer 214 and/or to the ground level image analyzer 216 for use in identifying instances of objects corresponding to the item class 102 and/or the identified related concepts. The example descriptions of objects may be different for different areas. For example, some geographic areas may have more fishing boats while other areas have more pontoon boats.

In some examples, the object feature determiner 218 sends relevant portions of the descriptions to each of the aerial image analyzer 214 and the ground level image analyzer 216. For example, the object feature determiner 218 may identify and provide descriptions corresponding to overhead perspectives of the objects to be identified to the aerial image analyzer 214. Conversely, the object feature determiner 218 identifies and provides descriptions of ground level perspectives of the objects to be identified to the ground level image analyzer 216. Example descriptions include visual characteristics, such as shapes, colors, sizes, and/or textures of objects and/or sub-components of the objects, combinations of sub-components, and/or spatial arrangements of sub-components. In the example of FIG. 2, a description of an object includes a set of features having corresponding weights. When the aerial image analyzer 214 or the ground level image analyzer 216 identifies an object under consideration as having a particular feature of an identifiable object (e.g., an outline shape of a boat), the aerial image analyzer 214 or the ground level image analyzer 216 increases the likelihood that an object under consideration is the identifiable object (e.g., a boat) based on the weight corresponding to the feature.

The example association table 222 may be populated and/or updated manually, and/or by machine learning (e.g., by associating concepts such as item classes, objects, activities, and/or economic information using relevance-based searching). In some examples, the example object feature determiner 218 updates the association table 222 by searching word association services based on a received item class 102.

The example object library 220 and/or the example association table 222 of FIG. 2 may be populated by, for example, persons with knowledge of the relationships between an item class 102 and other objects, activities, and/or economic information, and/or by persons who manually review a set of test images to determine characteristics corresponding to the item class 102. In some other examples, the object feature determiner 218 populates and/or updates the object library 220 and/or the association table 222 through trial-and-error and/or machine learning based on feedback associated with detected contextual features.

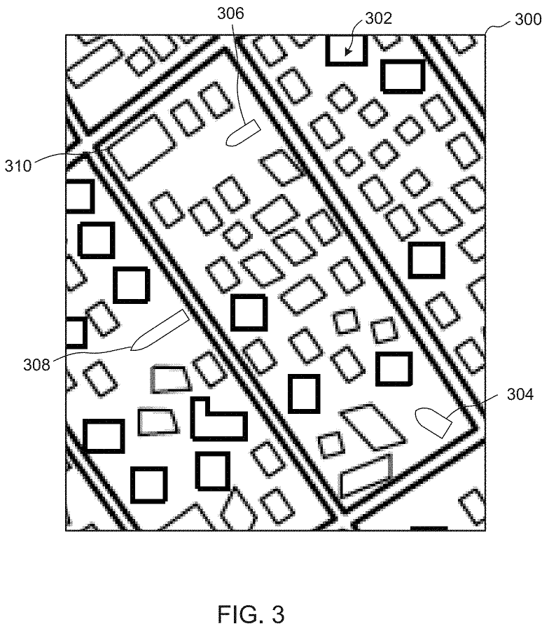

FIG. 3 is an example aerial image 300 that may be measured by the example measurement collector 106 of FIGS. 1 and/or 2 to measure a characteristic of a geographic area 302. The example aerial image collector 204 of FIG. 2 obtains the aerial image 300 of FIG. 3 from the aerial image repository 208.

Using the descriptions provided by the object library 220 via the object feature determiner 218, the example aerial image analyzer 214 analyzes the aerial image 300 images to identify objects related to the item class 102. Using the example item class 102 of “boats” in the example of FIG. 3, the example aerial image analyzer 214 of FIG. 2 identifies, using computer vision, counts of boats 304, 306, 308, 310 and/or boat types in the aerial image 300. For example, the aerial image analyzer 214 of FIG. 2 may use polygon detection to identify types of boats, such as a fishing boat 304, a recreational boat 306, a speedboat 308, a pontoon boats 310, sailboats, and/or any other type of boat.

In some examples, the aerial image analyzer 214 determines a type of vehicle based on the proportions of the polygons and/or the area of the polygons described in the descriptions from the object library 220. For example, speedboats have a long length-to-width ratio relative to other boats, so a length-to-width ratio greater than a threshold in combination with the pointed shape of the bow of the speedboat 308 may cause the aerial image analyzer 214 to identify the speedboat 308 as a speedboat. In some examples, particular colors are available on certain makes or models of boats. Therefore, the recognition of an object having particular colors that is identified on a body of water, or adjacent an object identified as a house, may be counted as a boat.

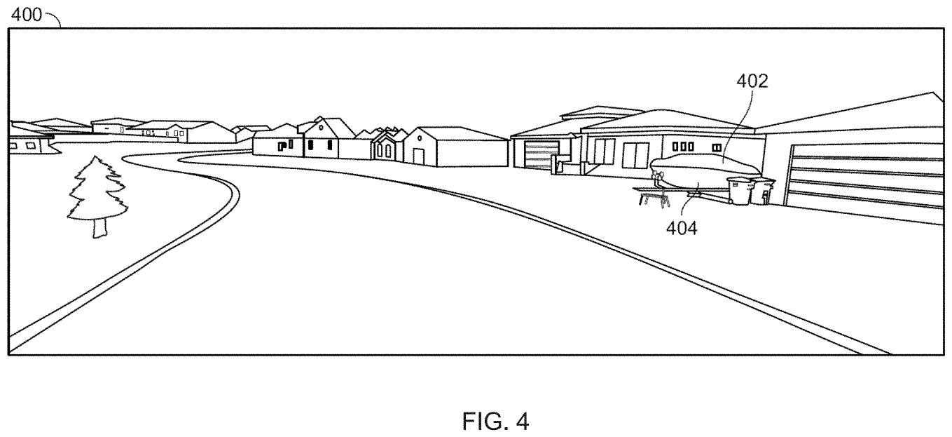

Similarly, the example ground level image analyzer 216 counts boats and/or boat types (e.g., boat objects that have similar features such as a curved hull but different features such as different sizes and/or proportions) from ground level images. FIG. 4 is an example ground level image 400 that may be measured by the example measurement collector 106 of FIGS. 1 and/or 2 to measure a characteristic of a geographic area. In the example of FIG. 4, the ground level image analyzer 216 identifies a boat 402 in the ground level image 400 based on the shape of the boat 402 and/or the presence of a boat trailer 404 carrying the boat 402. The ground level image analyzer 216 uses similar techniques as the aerial image analyzer 214 but uses different descriptions of objects that account for the different perspectives between aerial and ground level images. The different descriptions of an object are stored in the object library 220, with metadata relating the descriptions to respective ones of the perspectives.

In the example of FIG. 4, the ground level image 400 is one of a series of street level images taken in succession by a street view imaging service. As a result, multiple views of the boat 402 are available in images taken adjacent to the location at which the image 400 was taken. In response to identifying the boat 402 (or an object that may be a boat) in the image 400, the example ground level image analyzer 216 requests the ground level image collector 206 to obtain images adjacent to the image 400 (e.g., images that are likely to provide different perspectives of the boat 402). The example ground level image analyzer 216 may then analyze the adjacent images obtained from the ground level image repository 212 via the ground level image collector 206 to confirm or eliminate the identification of the boat 402 in the image 400.

In another example in which the item class 102 is “cars,” the example aerial image analyzer 214 of FIG. 2 identifies related objects using computer vision. For example, the aerial image analyzer 214 may identify parking areas, indicating a capacity for cars in that location in the geographic area 104, which in turn indicates a demand for cars in the geographic area 104.

In some examples, the ground level image analyzer 216 analyzes ground level images of locations that correspond to objects identified by the aerial image analyzer 214. For example, if the aerial image analyzer 214 identifies an object from an aerial image of a first location, the ground level image collector 206 obtains one or more images corresponding to the first location. The example ground level image analyzer 216 analyzes the one or more images to identify additional characteristic(s) of the identified object and/or to identify other objects related to the object identified by the aerial image analyzer 214.

Returning to FIG. 2, the example measurement collector 106 further includes an object feature learner 224 that receives identifications of objects from the aerial image analyzer 214 and/or the ground level image analyzer 216, identifies feature anomalies (e.g., anomalies between a description of an object and the observed characteristics of instances of the object), and/or confirms consistencies between the characteristics and the descriptions of objects. When the object feature learner 224 identifies a consistency between a description that is provided to the aerial image analyzer 214 and/or the ground level image analyzer 216 from the object library 220 (e.g., via the object feature determiner 218) and the object(s) in the analyzed image(s), the object feature learner 224 may increase a weight applied to the feature for the purposes of recognizing the corresponding object.

Conversely, when the object feature learner 224 identifies an anomaly between the description of an object (e.g., from the object library 220) and a characteristic of the object as identified by the aerial image analyzer 214 and/or the ground level image analyzer 216 (e.g., identified in spite of the anomaly, based on a sufficient number and/or combination of weights of other characteristics of the identified object from the description), the example object feature learner 224 may decrease the weight of the characteristic in the description and/or flag the characteristic for review by an administrator of the measurement collector 106. For example, the administrator may decide to fork the object in the object library 220 into multiple versions of the object, where the versions having some same or similar characteristics and some different characteristics in the respective descriptions. For example, the object type “cars” may be forked into coupes, sedans, sport utility vehicles, passenger trucks, and/or others.

The example aerial image analyzer 214 and/or the ground level image analyzer 216 output counts of the identified objects. The counts of objects may be sorted by type of object. In the example of FIG. 2, the aerial image analyzer 214 and/or the ground level image analyzer 216 further report locations (e.g., GPS coordinates) at which the objects are identified. The example aerial image analyzer 214 may identify the locations of the objects based on the location within the aerial image where the object is found and the locations of the edges of the aerial image. The location of the edges of the aerial image may be defined in metadata of the image and/or otherwise provided by the aerial image repository 208. The example ground level image analyzer 216 may estimate the location of an identified object using location metadata of the image in which the object is recognized.

In addition to searching images of the geographic area, the example measurement collector 106 measures activities associated with the item class 102 in the geographic area using an activity searcher 226. The example activity searcher 226 of FIG. 2 measures the presence, quantity, and/or popularity of activities that are associated with the item class 102. For example, the association table 222 of FIG. 2 associates objects such as the item class 102 with activities such as public and/or commercial services, events, associations, and/or any other type of activity. The example object feature determiner 218 provides activity types to the activity searcher 226 based on the specified item class 102 and the association table 222.

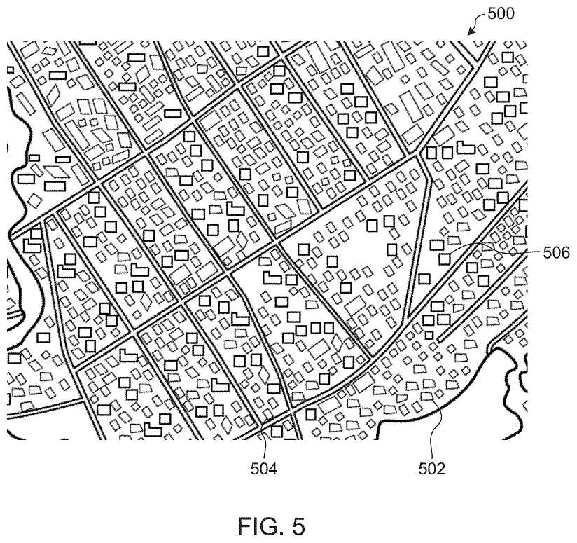

FIG. 5 shows an example geographic area 500 that may be searched by the example measurement collector 106 of FIGS. 1 and/or 2 to measure activities related to a specified item class (e.g., the item class 102 of FIGS. 1 and/or 2) as a characteristic of the geographic area 500.

The example activity searcher 226 searches (e.g., sends queries to) an activity database 228 based on the activities from the object feature determiner 218 and the geographic area 104. The example activity database 228 may be one or more public and/or proprietary databases relating activities to geographic areas. For example, the activity database 228 may include a commercial database describing the locations of various organizations and/or services, such as mapping services provided by Google Maps™ Foursquare®, TripAdvisor®, and/or any other similar services. In some examples, the activity database 228 includes activity data obtained from surveys and/or ground truth activity information collected via physical sampling or surveying. In such examples, the surveys and/or ground truth may be limited to reduce sampling costs associated with collecting the survey and/or ground truth data.

In the example of FIG. 5, in which the item class 102 is “boats,” the activity searcher 226 may search mapping services in the activity database 228 for services such as marinas, boat repair, boat rental, boat dealers, sporting goods, marine supply, fishing guides, fishing charters, and/or other boat-related services, in or within a threshold distance of the identified geographic area 500. The example activity searcher 226 identifies a boat dealer 502, a repair service 504, and a sporting goods store 506 in the example geographic area 500 based on one or more queries to the activity database 228.

In some examples, the activity database 228 includes location-based interest group databases, such as Meetup® or similar services. Using the example “boats” item class 102, the example activity searcher 226 may search the activity database 228 for fishing groups, boating groups, watersports groups, sailing groups, and/or any other boat-related groups in or within a threshold distance of the identified geographic area 104.

In some examples, the activity database 228 includes publicly accessible event calendars. Using the example “boats” item class 102, the example activity searcher 226 may search the activity database 228 for public and/or private events related to boating, sailing, fishing, boat racing, and/or any other boat-related events in or within a threshold distance of the identified geographic area 104. The example activity searcher 226 outputs the identification of the activity and, in some examples, the location of the activity. An example activity location may be the location of a service provider (e.g., a street address or GPS coordinates of a building) identified by the activity searcher 226.

Returning to FIG. 2, the example measurement collector 106 further includes an economic data collector 230. The example economic data collector 230 of FIG. 2 collects data representative of the economic capacity to purchase the specified item class 102 (and/or general economic capacity and/or purchasing ability, such as disposable income) in the geographic area. For example, the economic data collector 230 may make inferences about the geographic area based on features in the aerial images and/or the ground level images.

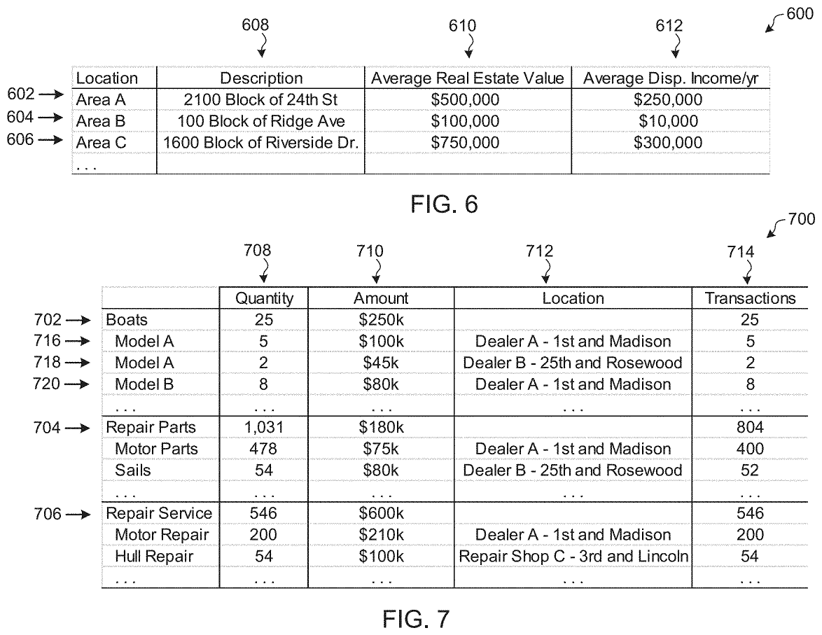

FIG. 6 is a table 600 including example economic information that may be collected and analyzed by the example measurement collector 106 of FIGS. 1 and/or 2 to measure economic capacity as a characteristic of a geographic area. The example table 600 includes locations 602, 604, 606 that are sub-regions of the geographic area (e.g., the geographic area 104 of FIGS. 1 and/or 2).

Each of the example locations 602-606 in FIG. 6 is provided with a description of the area 602-606. Example descriptions include keyword or plain language descriptions (e.g., the 1000 block of 1^{st} Street; the block bounded by 1^{st} Street, 2^{nd} Street, Madison Avenue, and Washington Boulevard; the Highland Park neighborhood; the 5^{th} Ward; the 7^{th} District; etc.), using GPS coordinates to define a boundary and/or key points of the boundary (e.g., two points of a rectangle), and/or any other method of describing the locations 602-606.

The example locations 602-606 in the table 600 may represent an area of any size within the geographic area 104, and/or may be selected by combining (e.g., averaging, summing, etc.) the economic data from a number of smaller sub-regions into a larger sub-region. For example, as the economic data collector 230 collects economic data such as estimated real estate values 608 for commercial and/or residential real estate, the economic data collector 230 may collapse the data for a block of real properties into an average real estate value (e.g., per square foot, per lot of X size, etc.) representative of the entire block.

In some examples, the economic data collector 230 calculates estimated residential building values (e.g., home values) from observable features (e.g., the features described above) in the aerial image(s), the ground level image(s), and/or supplemental data. For example, the economic data collector 230 may estimate home values in the geographic area 104 based on building densities, building textures, nearby building types, vehicle traffic, distances to designated locations, and/or landmarks. In the example of FIG. 2, the object feature determiner 218 provides descriptions of economic-related features to the aerial image analyzer 214 and/or the ground level image analyzer 216, obtains measurements of features in the aerial images and/or ground level images from the aerial image analyzer 214 and/or the ground level image analyzer 216, and provides the resulting measurements to the economic data collector 230. Example features that may indicate higher home values in some locations include: shorter distances to parks, bodies of water (e.g., lakes, rivers, oceans), and/or transportation features; higher elevations; desirable features on or near the property (e.g., waterfront property); the presence of swimming pools; higher concentrations of parked cars (e.g., on the sides of roads, off the roads, etc.); and/or roofs of a particular color. The example table 600 of FIG. 6 includes estimated average real estate values 610 for the example locations 602-606.

In some examples, the economic data collector 230 accesses online data sources, such as online real estate sources (e.g., www.zillow.com, etc.) and/or public records (e.g., taxation records, public assessment records, public real estate sales records, etc.) to estimate home values. In some examples, features observable from aerial and/or ground level image may indicate higher or lower home values. Additionally or alternatively, the example economic data collector 230 of FIG. 2 may combine the visually observed information described above with public real estate records (e.g., sales records, taxation records) to estimate the residential building values.

The example economic data collector 230 outputs the economic data and/or inferences drawn from the economic data. The example economic data collector 230 may group economic data that are obtained from a particular location or area to be specific to that location or area. In some examples, the economic data collector 230 outputs groups of economic characteristics (e.g., economic data) that respectively correspond to sub-regions of the geographic area, such as when a group of economic characteristics indicate a same or similar economic capacity for the corresponding sub-region. The example table 600 of FIG. 6 includes estimated average disposable income per year 612 determined by the economic data collector 230 for each of the example locations 602-606. The example average disposable income per year 612 of FIG. 6 may be per capita, per unit of area, or any other unit.

Returning to FIG. 2, the example measurement collector 106 includes a sales data collector 232. The example sales data collector 232 of FIG. 2 accesses a sales data repository 234 to access information related to sales of products and/or services related to the item class 102 and/or the geographic area 104. Using the association table 222, the example object feature determiner 218 determines products and/or services for which sales data are relevant to determining a market opportunity for the item class 102. The example sales data collector 232 searches one or more public and/or proprietary databases for sales data for the identified products and/or services. In some examples, the sales data repository 234 includes sales data obtained from surveys and/or ground truth sales information collected via physical sampling or surveying. In such examples, the surveys and/or ground truth may be limited to reduce sampling costs associated with collecting the survey and/or ground truth data.

For example, the sales data collector 232 accesses sales information from one or more partner entities, such as manufacturers, sellers, and/or providers within the geographic area 104 of goods and/or services identified as being related to the item class 102. In the example of the “recreational motor vehicle” item class 102, the example sales data collector 232 may query the sales data repository 234 for sales of cars, passenger trucks, recreational vehicles, all-terrain vehicles, motorbikes, motorcycles, dune buggies, snowmobiles, go-karts, boats, and/or personal watercraft, and/or replacement components for such products, from corresponding dealers from which sales information is available. Additionally or alternatively, the example sales data collector 232 may query the sales data repository 234 for repair, delivery, and/or storage service sales data.

The example sales data collector 232 outputs the sales data in association with locations where the corresponding sales occurred. For example, if a car dealership in the geographic area 104 provides car sales information, the example sales data collector 232 associates the location of the car dealership with the car sales information.

In some examples, the sales data collector 232 de-couples sales made at a point of purchase (e.g., a retail store or dealership) and/or via an electronic platform from a location associated with the point of purchase and/or electronic platform. This de-coupling may be performed when, for example, the home location of the purchaser can be identified as within the geographic area 104, but the location of purchase is outside the geographic area 104. In this manner, the example sales data collector 232 enhances the accuracy of sales that are attributable to the geographic area 104.

In some examples, the sales data collector 232 is used to measure sales data when developing a model for market opportunity for the item class 102, but is not used to measure sales data when applying the model to a geographic area for which a market opportunity is to be predicted.

FIG. 7 is a table 700 of example sales information that may be collected and analyzed by the example measurement collector 106 of FIGS. 1 and/or 2 to measure sales information related to a specified item class as a characteristic of a geographic area. The example table 700 of FIG. 7 includes sales information 702 for objects in the item class 102 of FIGS. 1 and/or 2, and sales information 704, 706 for products and/or services related to the item class 102 (e.g., as determined using the association table 222 of FIG. 2). In the example of FIG. 7, the item class 102 is “boats” and related products and/or services include “repair parts” and “repair service.”

The sales information in the example table 700 of FIG. 7 includes a sales quantity 708 (e.g., a number of items sold), a sales amount 710 (e.g., in currency such as U.S. dollars), a sales location 712 (e.g., GPS coordinates or another location designation, such as an online or Internet sale), and a number of transactions 714 (e.g., transactions in which the sales quantity 708 and/or the sales amount 710 occurred) for each of the sales information 702-606.

Each of the products and/or services for which the sales information 702-706 is present in FIG. 7 includes sub-types of those products and/or services. For example, boats are split into Model A and Model B, where the sales information 702 includes sales information 716, 718 for the same boat model (Model A) from multiple sources and sales information 720 for a second boat model (Model B).

Returning to FIG. 2, the example measurement collector 106 further includes a consumer data collector 236 that collects consumer data based on the geographic area 104. Example consumer data includes demographic data such as age, gender, race, household income, number of children, education, and/or any other demographic information.

The example consumer data collector 236 also collects market segmentation data based on the geographic area 104. Example market segmentation data includes the prevalence of defined market segments (e.g., PRIZM market segments defined by The Nielsen Company, or any other defined market segments), behavioral information (e.g., products used by people within the geographic area 104, price sensitivity, brand loyalty, and/or desired benefits of purchases), and/or psychographic information (e.g., information about values, attitudes and lifestyles of people in the geographic area 104). In some examples, the consumer data collector 236 collects data that partially overlaps with the activity data collected by the activity searcher 226.

The example consumer data collector 236 collects the demographic data and/or market segmentation data from a consumer data repository 238. The example consumer data repository 238 may obtain consumer data from official sources (e.g., official and/or governmental population census measurements), commercial sources (e.g., consumer measurement services, such as services provided by The Nielsen Company), surveys of people located within the geographic area (e.g., Internet surveys, in-person surveys, telephone surveys, etc.), and/or by obtaining consumer data from partner entities that collect such data during the course of business (e.g., online social networks, credit agencies, and/or any other entities). The sources of demographic data and/or market segmentation data discussed above are merely examples, and any other sources may be used.

Additionally or alternatively, the example consumer data collector 236 of FIG. 2 collects electronic device data for consumer devices, such as location data from GPS devices, mobile phones, and/or any other devices for which location data may be measured and/or deduced. The example consumer data collector 236 may request and/or receive the location data from a device location database 240. The example device location database 240 stores from available sources of location information. For example, the device location database 240 may store location data obtained based on IP addresses, connections to wireless access points for which a location is known, self-reporting by devices that can measure their own location, triangulation performed by wireless communications service providers (e.g., using wireless network base stations), and/or any other location measurement techniques. In the example of FIG. 2, the device location database 240 and/or the consumer data collector 236 may have partnerships with one or more services capable of obtaining location information for devices within the geographic area 104. Examples of such services may include mobile communications network providers (e.g., Verizon Wireless®, AT&T®, Sprint®, T-Mobile®, etc. in the United States, or other providers for different countries), wireless communications network proprietors (e.g., owners and/or operators of wireless access points that provide wireless network services), web site operators that collect location data via their web sites, and/or any other services.

In some examples, the consumer data collector 236 of FIG. 2 may obtain and use the location data (and/or corresponding timestamps of the location data) to determine the relative usage, visitation, and/or popularity of particular location(s) within the geographic area 104 based on a number of occurrences of devices being identified as located at the particular location(s). For example, when the item class 102 is motor-based devices (e.g., cars, boats, motorcycles, recreational vehicles, etc.), the example consumer data collector 236 may collect location data that indicates a number of devices and/or occurrences of devices at motor-centric locations such as repair shops, fueling stations, events oriented around motor-based devices (e.g., car shows, boat shows, car enthusiast events, etc.). Additionally or alternatively, the consumer data collector 236 may use the location data to track movement of devices between a location that is correlative or anti-correlative for the item class 102 to one or more sub-regions of the geographic area 104. Using movement data, the example consumer data collector 236 may determine which of the sub-regions have higher and/or lower percentages of people travel to the location.

Additionally or alternatively, the example consumer data collector 236 may collect location data that is anti-correlative with the item class 102. In the example of motor-based devices, the example consumer data collector 236 may collect location data corresponding to public transportation routes (e.g., to estimate a number of people in the geographic area 104 who use public transportation to travel rather than personal vehicles) and/or to services that are anti-correlated with an interest in motor-based devices.

The example measurement collector 106 of FIG. 2 outputs the characteristic measurements 202 measured by the aerial image analyzer 214, the example ground level image analyzer 216, the example activity searcher 226, the example economic data collector 230, and/or the example sales data collector 232. For example, the aerial image analyzer 214 and/or the ground level image analyzer 216 output count(s) of objects related to the item class 102 counted from collected images of the geographic area 104. The counts of objects may be sorted by the types of objects. The example activity searcher 226 outputs count(s) of activities related to the item class 102 and the geographic area 104. The example economic data collector 230 outputs one or more characterizations or estimates of the economic capacity of the geographic area 104. The characterizations or estimates may be determined for sub-regions of the geographic area 104. The example sales data collector 232 outputs sales information for products and/or services related to the item class 102 in the geographic area 104.

FIG. 8 is a block diagram of an example implementation of the example centricity modeler 108 of FIG. 2. The example centricity modeler 108 of FIG. 8 receives characteristic measurements 202 from the example measurement collector 106 of FIGS. 1 and 2 and generates a centricity model 802 describing a relationship between the characteristic measurements 202 and a market opportunity for the item class 102. In the example of FIG. 8, the relationship is expressed as an estimated sales opportunity or a probability of purchasing product(s) and/or service(s) in the item class 102 per capita. For example, the centricity model 802 describes a probability per capita of purchasing a defined quantity of a product or service in the item class 102, such as the probability of purchasing a recreational motor vehicle (or a specific type of recreational motor vehicle). In the example of FIG. 8, the centricity model 802 has a location-based component that enables application of the centricity model 802 to different regions of a geographic area based on the locations associated with measured characteristics in the geographic area.

The example centricity modeler 108 of FIG. 8 includes a propensity modeler 804 and a capacity modeler 806. The example propensity modeler 804 generates a propensity model based on a subset of the characteristic measurements 202 that indicate the interest in the item class 102 from people in the geographic area 104. For example, the propensity modeler 804 of FIG. 8 may use counts of objects related to the item class 102 counted by the aerial image analyzer 214 and/or the ground level image analyzer 216, the measured activities associated with the item class 102 measured by the activity searcher 226, and the sales information measured by the sales data collector 232.

The example propensity modeler 804 performs regression analysis to estimate the relationships between identified objects (e.g., objects related to the item class 102) and sales (e.g., sales of the item class 102, sub-types of the item class 102, and/or objects associated with the item class 102), activities (e.g., activities related to the item class 102) and sales (e.g., sales of the item class 102, sub-types of the item class 102, and/or objects associated with the item class 102), and/or identified objects (e.g., objects related to the item class 102) and activities (e.g., activities related to the item class 102), among others.

In some examples, the propensity modeler 804 generates a propensity model 808 as function of distance from identified object locations (and the types of those objects), activity locations (and the types of those activities), and/or sales locations (and the identifications and quantities of the products and/or services sold). Additionally or alternatively, the propensity modeler 804 generates the propensity model 808 as function of densities of identified objects, activities, and/or sales in an area. Thus, a location (e.g., a point) within the geographic area 104, as well as locations of other identified objects, the types of those identified objects, locations of activities, and the types of those activities may then be input into the propensity model 808 to calculate an estimated interest or propensity to purchase the item class 102.

In some examples, presences and/or counts of identified objects and/or activities are weighted more heavily than locations of the objects and/or activities. For example, a count of the number of boats in a geographic area may be weighted more highly for determining the relationships in the propensity model 808 than the locations at which the boats are found. This may be due to, for instance, a high willingness and/or degree of mobility by persons in the geographic area to travel to engage in a market for the item class. For example, owners of boats are likely to understand that a minimum amount of travel is necessary to make use of a trailered boat by putting it in a public or private waterway, and to be willing to undertake such travel.

An example relationship that may be generated by the example propensity modeler 804 is shown below in Equation 1.

$$P = [ \begin{matrix}{I}_{1} \\ … \\ {I}_{n}\end{matrix} ] * [ \begin{matrix}\frac{1}{d {i}_{1}} & … & \frac{1}{d {i}_{n}}\end{matrix} ] + [ \begin{matrix}{A}_{1} \\ … \\ {A}_{m}\end{matrix} ] * [ \begin{matrix}\frac{1}{d {a}_{1}} & … & \frac{1}{d {a}_{m}}\end{matrix} ] + [ \begin{matrix}{D}_{1} \\ … \\ {D}_{o}\end{matrix} ] * [ \begin{matrix}\frac{1}{d {d}_{1}} & … & \frac{1}{d {d}_{o}}\end{matrix} ] \qquad ( Equation 1 )$$

In Equation 1 above, P is the propensity of a given location (e.g., a point in the geographic area 104) to purchase the item class 102 for which the relationship is generated. The [I] matrix is an n×1 matrix that includes n objects identified by the measurement collector 106 (e.g., via the aerial image analyzer 214 and/or the ground level image analyzer 216), and the respective values of the objects (e.g., values based on how the objects affect the centricity of the population with respect to the item class). The [A] matrix is an m×1 matrix that includes m activities identified by the measurement collector 106 (e.g., via the activity searcher 226), and the respective values of the activities (e.g., values based on how the activities affect the centricity of the population with respect to the item class). The [D] matrix is an o×1 matrix that includes o sets of consumer data (e.g., demographic data and/or market segment data) identified by the measurement collector 106 (e.g., via the consumer data collector 236), and the respective values of the consumer data (e.g., values based on how the consumer data affect the centricity of the population with respect to the item class). The [1/d] matrices include the inverses of the distances from the given location to each of the objects in [I], the activities in [A], and the consumer data in [D]. For example, di₁ is the distance between the given location and the location at which the object I₁ is found.

The example propensity modeler 804 of FIG. 8 identifies the values of the objects in [I], the activities in [A], and/or the consumer data in [D] of Equation 1 to determine the relationship. The example propensity modeler 804 may further determine exponents to be applied to the distances di, dd, and/or da, functions to account for non-linearities in the relationship, and/or any other modifications to the example Equation 1. While Equation 1 is an example of a relationship, it is intended to be limiting and any other appropriate relationship may be used.

While the example propensity modeler 804 is illustrated in FIG. 8 as one modeler to account for identified objects, activities, and/or consumer data, the example propensity modeler 804 may be implemented using any number of models, sub-models, and/or data layers to, for example, enable easier changes to the relationships between the models, the sub-models, and/or the data layers.

The example capacity modeler 806 of FIG. 8 obtains the economic capacity information in the characteristic measurements 202. The example capacity modeler 806 models the estimated economic capacity (e.g., economic capacity per capita, such as disposable income, net worth, etc.) of the geographic area 104 as a whole and/or estimated economic capacities of sub-regions within the geographic area 104. For example, the characteristic measurements 202 may indicate that some sub-regions of the geographic area 104 have a first economic capacity and other sub-regions of the geographic area of a second economic capacity. In some examples, the capacity modeler 806 generates a capacity model 810 as function of location within the geographic area 104. A location (e.g., a point) within the geographic area 104 may then be input into the capacity model 810 to calculate an estimated economic capacity.

An example relationship that may be generated by the example capacity modeler 806 is shown below in Equation 2.

$$C = [ \begin{matrix}{E}_{1} \\ … \\ {E}_{l}\end{matrix} ] * [ \begin{matrix}\frac{1}{{de}_{1}} & … & \frac{1}{d {e}_{l}}\end{matrix} ] \qquad ( Equation 2 )$$

In Equation 2 above, C is the economic capacity of a given location (e.g., a point in the geographic area 104) to purchase the item class 102 for which the relationship is generated. The [E] matrix is an 1×1 matrix that economic information collected by the measurement collector 106 (e.g., via the economic data collector 230), and the respective values of the collected economic information (e.g., values based on how the objects affect the centricity of the population with respect to the item class). The [l/d] matrix includes the inverses of the distances from the given location to each of the economic data in [E]. For example, de₁ is the distance between the given location and the location for which the economic data E₁ is identified.

The example capacity modeler 806 of FIG. 8 identifies the values of the economic data in [E] of Equation 2 to determine the relationship. The example capacity modeler 806 may further determine exponents to be applied to the distances de, functions to account for non-linearities in the relationship, and/or any other modifications to the example Equation 2. While Equation 2 is an example of a relationship, it is intended to be limiting and any other appropriate relationship may be used.

While the example capacity modeler 806 is illustrated in FIG. 8 as one modeler to account for economic data, the example capacity modeler 806 may be implemented using any number of models, sub-models, and/or data layers to, for example, enable easier changes to the relationships between the models, the sub-models, and/or the data layers.

The example centricity modeler 108 of FIG. 8 includes a model combiner 812 to combine the propensity model 808 and the capacity model 810 into a centricity model 802. The example model combiner 812 applies weights to the propensity model 808 and/or the capacity model 810 to weight the models to attempt to fit the centricity model 802 to the observed sales information. An example combination of the propensity model 808 and the capacity model 810 is shown below in Equation 3.

O=W_{P}*P+W_{C}*C (Equation 3)

In Equation 3, W_{P} is a weight applied by the model combiner 812 to the propensity P obtained from the propensity model 808, and W_{C} is a weight applied by the model combiner 812 to the capacity C obtained from the capacity model 810. The example model combiner 812 may select the weights W_{P}, W_{C} based on the item class 102 and the relative importance of economic capacity to a market for the item class 102. For example, relatively inexpensive and/or commoditized item classes may have a lower weight W_{C} on economic capacity, while more expensive item classes may have a higher weight W_{C} on economic capacity. While Equation 3 illustrates a linear relationship, any other type of equation or model may be used as an alternative to a linear relationship to combine the propensity model 808 and the capacity model 810.

The example propensity modeler 804, the example capacity modeler 806, and/or the example model combiner 812 use one or more machine learning techniques, such as ensemble methods (e.g., using multiple learning techniques or models and combining the outputs of the techniques or models), to update the values of the objects and/or activities in Equations 1 and/or 2, and/or to update the weights W_{P} and/or W_{C} in Equation 3. For example, the propensity modeler 804, the example capacity modeler 806, and/or the example model combiner 812 may modify values and/or weights based on observed ground truth.

In some examples, the propensity modeler 804, the example capacity modeler 806, and/or the example model combiner 812 may access retail measurement data, such as Nielsen Scantrack data and/or Retail Measurement Services data (e.g., reports of sales information for products) to determine the values for the [I], [A], [D], and/or [E] matrices, and/or the weights W_{P} and/or W_{C}. For example, the propensity modeler 804, the example capacity modeler 806, and/or the example model combiner 812 may use the retail measurement data to identify the strengths of correlations between the item class 102 and activities, objects, consumer data, and/or economic information. The strengths of the correlations may then be used to determine the values for the [I], [A], [D], and/or [E] matrices, and/or the weights W_{P} and/or W_{c}.

In some examples, the propensity modeler 804, the example capacity modeler 806, and/or the example model combiner 812 may use past measurements of objects, activities, consumer data, and/or economic data, and/or changes in measurements of objects, activities, consumer data, and/or economic data over time, to generate the propensity model 808, the capacity model 810, and/or the centricity model 802. For example, applying changes in the count(s) and/or distribution(s) of objects, popularit(ies) and/or location(s) of activities, changes in consumer data, and/or changes in economic data may improve the propensity model 808, the capacity model 810, and/or the centricity model 802 when compared to using only a single set of measurements (e.g., current or most recent measurements).

The model combiner 812 provides the centricity model 802 to a model tester 814. The example model tester 814 of FIG. 8 tests the centricity model 802 using known market data 818 (e.g., known economic data, sales data, activity data, and/or object data for a geographic area). The known market data 818 may be obtained by physically surveying or sampling market data, economic data, sales data, activity data, and/or object data (e.g., using people performing the surveying and/or sampling). For example, known characteristics of a geographic area may be determined from performing counting, sampling, and/or other procedures to determine the “ground truth.” As used herein, “ground truth” refers to information collected at the location and intended to accurately depict the characteristics of the area. The ground truthing may be performed by, for example, a market survey and/or research service.

If the example model tester 814 identifies more than a threshold error between the centricity model 802 and the known market data 818, the example model tester 814 feeds back error information 816 to the example propensity modeler 804, the capacity modeler 806, and/or the model combiner 812. Example error information 816 includes errors at individual locations in a geographic area corresponding to the known market data 818, and portions of the known market data 818 considered to contribute to the sales information at that location in the known market data 818. For example, the model tester 814 may feed back relevant objects, activities, and/or economic data near the location(s) of the error. The propensity modeler 804, the capacity modeler 806, and/or the model combiner 812 adjust the weights W_{P}, W_{C}, [O, ], [A], and/or [E] applied to the characteristic measurements 202 for generating the propensity model 808, the capacity model 810, and/or the centricity model 802.

In some examples, the propensity modeler 804 and the capacity modeler 806 are combined to one modeler that, in addition to using the characteristic data described above with reference to the propensity modeler 804, also uses economic data (e.g., determined by the economic data collector 230. In such examples, the propensity modeler 804 uses regression analysis to estimate relationships between the economic data (e.g., data indicating economic capacity, data characterizing the commercial environment at or near a geographic location, etc.) and identified objects (e.g., objects related to the item class 102), activities (e.g., activities related to the item class 102) and/or sales (e.g., sales of the item class 102, sub-types of the item class 102, and/or objects associated with the item class 102).

While the example propensity modeler 804 and the example capacity modeler 806 use regression analysis, any other analysis method may be used to quantitatively estimate the relationships between the characteristic measurements 202 collected by the measurement collector 106.

Because the known market data 818 is similar to the information used to generate the centricity model 802, the model tester 814 and/or the known market data 818 may be omitted in cases in which such data are unavailable (e.g., when ground truth is not available for an item class).

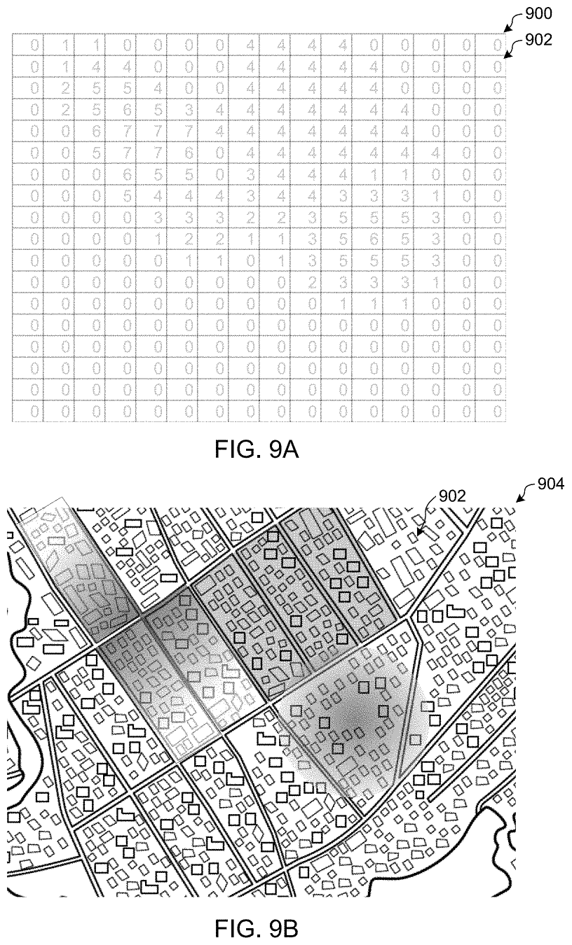

FIG. 9A is a numerical representations of an example heat map 900 of an estimated market opportunity for a specified item class and a geographic area 902, which is generated by the example centricity estimator 110 of FIG. 1 using a centricity model generated by the example centricity modeler 108 of FIGS. 1 and/or 8.

The example heat map 900 of FIG. 9A divides the geographic area 902 into blocks representative of sub-regions of the geographic area 902. The example centricity estimator 110 of FIG. 1 generates the heat map 900 by applying the centricity model generated by the centricity modeler 108 to a set of characteristic measurements obtained from the example measurement collector 106.

FIG. 9B is a graphical heat map 904 representative of the example heat map 900 of FIG. 9A. The example graphical heat map 904 of FIG. 9B may be generated to provide a more readable version of the heat map 900 for viewing. Additionally, the example graphical heat map 904 shows gradients that illustrate the increases and decreases in market opportunity when moving from one point in the geographic area 902 to another point. For example, in the heat map 904 of FIG. 9B, moving from lighter-shaded areas to darker-shaded areas signifies an increase in the market opportunity according to the centricity model.

The example centricity modeler 108 is described with respect to FIG. 8 as performing supervised machine learning. That is, the example centricity modeler 108 of FIG. 8 generates the propensity model 808, the capacity model 810, and/or the centricity model 802 to calculate a known outcome (e.g., the known market data 818). However, the example the propensity model 808, the capacity model 810, and/or the centricity model 802 may additionally or alternatively be implemented to perform unsupervised machine learning. For example, the propensity model 808, the capacity model 810, and/or the centricity model 802 may attempt to determine patterns of market opportunity, centricity, and/or demand using the characteristic measurements 232 and without having a known outcome to be achieved. In such examples, the centricity model 802 may include one or more relationship(s) between object(s), activit(ies), consumer data, economic data, and/or sales data. Examples of such relationship(s) are relationships that indicate market opportunity, centricity, and/or demand.

While example manners of implementing the market opportunity determiner 100 of FIG. 1 are illustrated in FIGS. 2 and 8, one or more of the elements, processes and/or devices illustrated in FIGS. 2 and/or 8 may be combined, divided, re-arranged, omitted, eliminated and/or implemented in any other way. Further, the example measurement collector 106, the example centricity modeler 108, the example centricity estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example association table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example propensity modeler 804, the example capacity modeler 806, the example model combiner 812, the example model tester 814 and/or, more generally, the example market opportunity determiner 100 of FIGS. 1, 2, and/or 8 may be implemented by hardware, software, firmware and/or any combination of hardware, software and/or firmware. Thus, for example, any of the example measurement collector 106, the example centricity modeler 108, the example centricity estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example association table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example propensity modeler 804, the example capacity modeler 806, the example model combiner 812, the example model tester 814 and/or, more generally, the example market opportunity determiner 100 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example measurement collector 106, the example centricity modeler 108, the example centricity estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example association table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example propensity modeler 804, the example capacity modeler 806, the example model combiner 812, and/or the example model tester 814 is/are hereby expressly defined to include a tangible computer readable storage device or storage disk such as a memory, a digital versatile disk (DVD), a compact disk (CD), a Blu-ray disk, etc. storing the software and/or firmware. Further still, the example market opportunity determiner 100 of FIG. 1 may include one or more elements, processes and/or devices in addition to, or instead of, those illustrated in FIG. 1, and/or may include more than one of any or all of the illustrated elements, processes and devices.

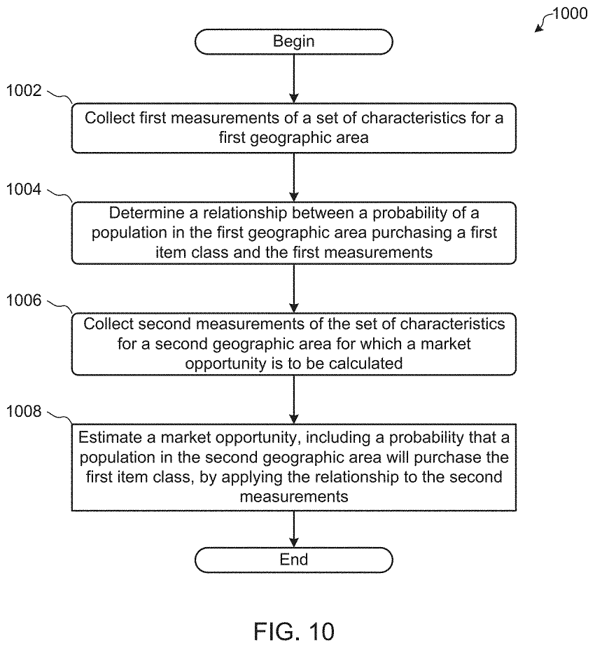

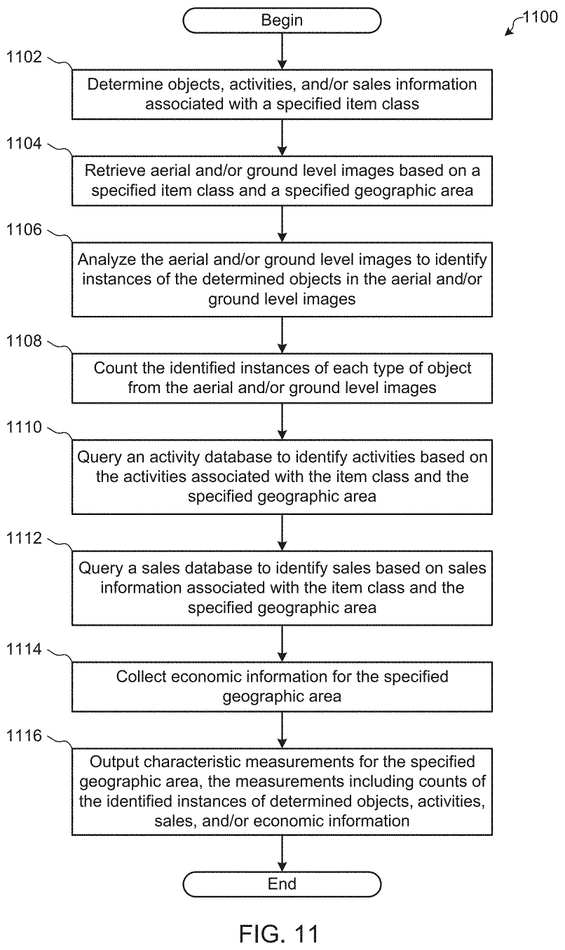

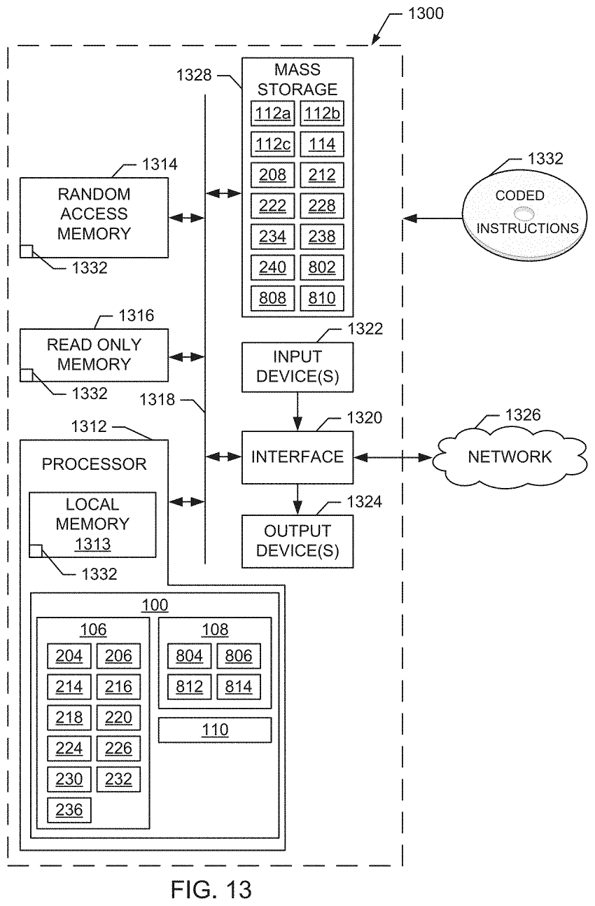

Flowcharts representative of example machine readable instructions for implementing the market opportunity determiner 100 of FIG. 1 are shown in FIGS. 10, 11, and 12. In these examples, the machine readable instructions comprise programs for execution by a processor such as the processor 1312 shown in the example processor platform 1300 discussed below in connection with FIG. 13. The programs may be embodied in software stored on a tangible computer readable storage medium such as a CD-ROM, a floppy disk, a hard drive, a digital versatile disk (DVD), a Blu-ray disk, or a memory associated with the processor 1312, but the entire programs and/or parts thereof could alternatively be executed by a device other than the processor 1312 and/or embodied in firmware or dedicated hardware. Further, although the example programs are described with reference to the flowcharts illustrated in FIGS. 10, 11, and/or 12, many other methods of implementing the example market opportunity determiner 100 may alternatively be used. For example, the order of execution of the blocks may be changed, and/or some of the blocks described may be changed, eliminated, or combined.

As mentioned above, the example processes of FIGS. 10, 11, and/or 12 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 10, 11, and/or 12 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and transmission media. As used herein, when the phrase “at least” is used as the transition term in a preamble of a claim, it is open-ended in the same manner as the term “comprising” is open ended.

FIG. 10 is a flowchart representative of example machine readable instructions 1000 which may be executed to implement the example market opportunity determiner 100 of FIG. 1 to measure a market opportunity of an item class 102 in a geographic area 104.

The example measurement collector 106 of FIG. 1 collects first measurements of a set of characteristics for a first geographic area (block 1002). The first geographic area may be a calibration area or a model-generating area, for which sales information associated with the item class 102 is known. The set of characteristics may include, for example, measurements of products and/or services within the specified item class and/or products and/or services related to but not within the specified item class. In some examples, the set of characteristics includes measurements of activities related to the item class. In some examples, the set of characteristics includes sales information for products and/or services within the specified item class and/or products and/or services related to but not within the specified item class. In some examples, the set of characteristics includes economic information for the first geographic area. Example instructions that may be executed to implement block 1002 are disclosed below with reference to FIG. 11.

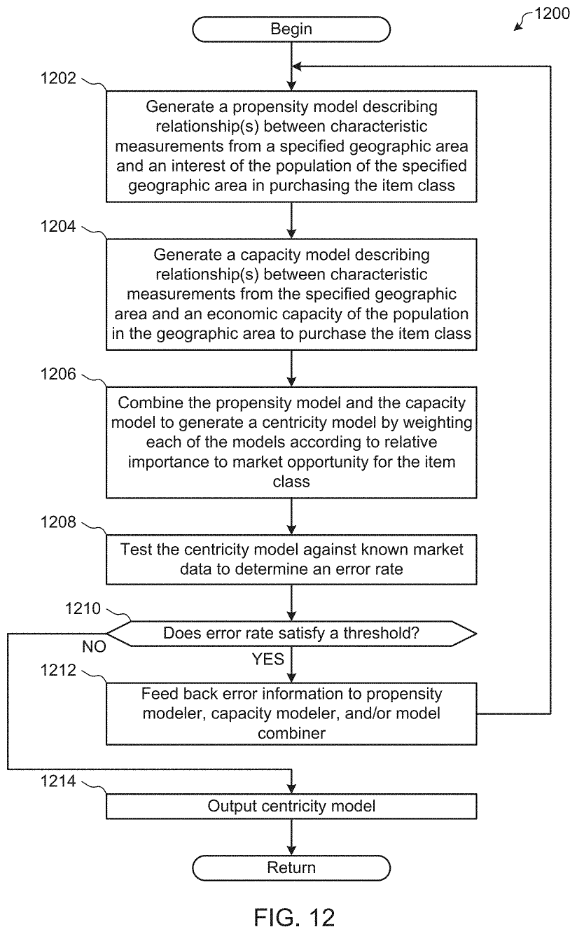

The example centricity modeler 108 of FIG. 1 determines a relationship between a) a probability of a population in the first geographic area purchasing the item class and b) the first measurements of the set of characteristics. In some examples, determining the relationship between the probability and the first measurements includes determining a model describing the first probability as a function of position within the first area. In some examples, the model includes a propensity model that describes the interest of a population in the item class and/or an economic capacity model that describes the economic capacity of the population in the geographic area to purchase the item class. Example instructions to implement block 1004 are disclosed below with reference to FIG. 12.

The example measurement collector 106 of FIG. 1 also collects second measurements of the set of characteristics for a second geographic area for which a market opportunity is to be calculated (block 1006). The example second measurements may be measurements of the same set of characteristics as the first measurements collected in block 1002. Example instructions to implement block 1006 are disclosed below with reference to FIG. 11.

The example centricity estimator 110 of FIG. 1 estimates a market opportunity, including a probability that a population in the second geographic area will purchase the first item class, by applying the relationship to the second measurements (block 1008). For example, the centricity estimator 110 may apply the second measurements obtained by the measurement collector 106 to the relationship or model determined by the centricity modeler 108. In some examples, the centricity estimator 110 estimates the market opportunity (e.g., the probability) as a function of position within the second geographic area. The example centricity estimator 110 estimates the market opportunity in units such as sales per population at a specific location or area in the second geographic area.

The example instructions 1000 of FIG. 10 end. In some examples, the instructions 1000 iterate to create and/or update a centricity model for the same or another item class and/or apply a centricity model to another geographic area.

FIG. 11 is a flowchart representative of example machine readable instructions 1100 which may be executed to implement the example market opportunity determiner 100 of FIG. 1 to collect measurements of a set of characteristics for a geographic area. The example instructions 1100 of FIG. 11 may be executed to implement block 1002 and/or block 1006 of FIG. 10 to collect measurements.

The example object feature determiner 218 of FIG. 2 determines objects, activities, and/or sales information associated with a specified item class (block 1102). For example, the object feature determiner 218 may receive an indication of the item class 102 and look up the item class in the association table 222 to determine related products, services, and/or activities associated with the item class 102.

The example aerial image collector 204 and/or the example ground level image collector 206 of FIG. 2 retrieve aerial and/or ground level images based on the specified item class 102 and a specified geographic area 104 (block 1104). For example, the aerial image collector 204 may query the aerial image repository 208 for aerial images of the geographic area 104 and/or the ground level image collector 206 may query the ground level image repository 212 for ground level images based on the item class 102 and the geographic area 104. The specified geographic area 104 may be an area in which a market for the item class 102 is known (e.g., when implementing block 1002 of FIG. 10) and/or an area in which a market for the item class 102 is to be estimated (e.g., when implementing block 1006 of FIG. 10).

The example aerial image analyzer 214 and/or the example ground level image analyzer 216 analyze the aerial and/or ground level images to identify instances of the determined objects in the aerial and/or ground level images (block 1106). For example, the aerial image analyzer 214 and/or the example ground level image analyzer 216 use computer vision and descriptions of objects related to the item class 102 (e.g., provided by the object library 220 of FIG. 2) to identify the presence of objects in the aerial and/or ground level images.

The example aerial image analyzer 214 and/or the example ground level image analyzer 216 count the identified instances of each type of object identified from the aerial and/or ground level images (block 1108). Using the example item class of “motor vehicles,” the aerial image analyzer 214 and the example ground level image analyzer 216 each respectively count the number of “boat” objects identified in the aerial and/or ground level images, the number of “car” objects identified in the aerial and/or ground level images, and so on for each type of object specified by the object feature determiner 218.

The example activity searcher 226 of FIG. 2 queries an activity database (e.g., the activity database 228) to identify activities based on the activities associated with the item class 102 and the specified geographic area 104 (block 1110). For example, the activity searcher 226 may query the activity database 228 to identify services, groups, events, and/or other activity types identified by the object feature determiner 218 and are within and/or near the geographic area 104.

The example sales data collector 232 queries a sales database (e.g., the sales data repository 234 of FIG. 2) to identify sales based on sales information associated with the item class 102 and the specified geographic area 104 (block 1112). For example, the sales data collector 232 may obtain sales information for products and/or services within the item class 102 and/or products and/or services determined by the object feature determiner 218 to be related to the item class 102. The example sales data collector 232 also collects location information corresponding to the collected sales information, such as locations where sales occurred.

The example economic data collector 230 of FIG. 2 collects economic information for the specified geographic area (block 1114). For example, the economic data collector 230 collects economic information such as real estate values, individual incomes, local commercial and/or retail characteristics, and/or any other information indicating the economic capacity of the geographic area 104 (and/or sub-regions of the geographic area 104) to purchase products and/or services corresponding to the item class 102.

The example measurement collector 106 outputs characteristic measurements 202 for the specified geographic area 104 (block 1116). The example characteristic measurements 202 include counts of the identified instances of determined objects, activities, sales, and/or economic information. The measurement collector 106 provides the characteristic measurements 202 to the centricity modeler 108 and/or the centricity estimator 110.

The example instructions 1100 of FIG. 11 end and return control to a calling function, such as block 1002 or block 1006 of FIG. 10.

FIG. 12 is a flowchart representative of example machine readable instructions 1200 which may be executed to implement the example market opportunity determiner 100 of FIG. 1 to determine a relationship between a probability of purchasing a first item class and collected measurements of a set of characteristics. The example instructions 1100 of FIG. 11 may be executed to implement block 1002 and/or block 1006 of FIG. 10 to collect measurements.

The example propensity modeler 804 of FIG. 8 generates a propensity model 808 describing relationship(s) between the characteristic measurements 202 for the specified geographic area 104 and an interest of a population of the specified geographic area in purchasing a specified item class 102 (block 1202). For example, the propensity modeler 804 may model relationship(s) between: a) objects identified from images of the geographic area 104 and sales of products and/or services in the item class 102 and/or b) activities related to the item class 102 and sales of products and/or services in the item class 102. The propensity model 808 reflects the interest of the population in the item class 102, as opposed to the population being interested in other item classes 102 and/or pursuits.

The example capacity modeler 806 of FIG. 8 generates a capacity model 810 describing relationship(s) between characteristic measurements 202 for the specified geographic area 104 and an economic capacity of the population in the geographic area 104 to purchase the item class 102 (block 1204). For example, the capacity modeler 806 may model relationship(s) between sales information and economic information collected for the geographic area 104. The capacity model 810 represents the ability of the geographic area 104 (and/or sub-regions of the geographic area 104) to purchase the item class 102.

The example model combiner 812 of FIG. 8 combines the propensity model 808 and the capacity model 810 to generate a centricity model 802 by weighting each of the models 808, 810 according to relative importance to market opportunity for the item class 102 (block 1206). For example, the model combiner 812 may apply weights to each of the propensity model 808 and/or the capacity model 810 based on the nature of the item class 102 (e.g., the price of the item class 102 relative to substitutes for the item class 102).

The example model tester 814 tests the centricity model 802 against known market data 818 to determine an error rate (block 1208). For example, the model tester 814 may input a known set of characteristic measurements into the centricity model 802 to obtain an estimated market opportunity. The example model tester 814 then compares the estimated market opportunity (e.g., predicted sales per capita and/or per location or area) to a known market opportunity (e.g., actual sales per capita and/or per location or area). The difference between the estimated market opportunity and the known market opportunity is an error rate. The error rate for the centricity model 802 may be a sum of individual errors calculated for sub-regions in the geographic area that corresponds to the known market information.

The example model tester 814 determines whether the error rate satisfies a threshold error rate (block 1210). For example, the model tester 814 may determine whether the total error calculated from testing the centricity model 802 using the known market data 818 is more than a threshold error.

When the error rate satisfies a threshold error rate (e.g., when there is at least a threshold error between a market opportunity calculated from the centricity model 802 and the known market data 818) (block 1210), the example model tester 814 feeds back error information to the propensity modeler 804, the capacity modeler 806, and/or the model combiner 812 (block 1212). The error information fed back to the propensity modeler 804, the capacity modeler 806, and/or the model combiner 812 may include, for example, a total error for the tested geographic area corresponding to the known market data 818 and/or localized errors for locations and/or sub-regions within the tested geographic area.

When the error rate does not satisfy the threshold error rate (e.g., when there is less than a threshold error between a market opportunity calculated from the centricity model 802 and the known market data 818) (block 1210), the example centricity modeler 108 outputs the centricity model 802 (block 1214). The example centricity modeler 108 may output the centricity model 802 to the centricity estimator 110 for use in estimating a market opportunity for the item class 102 for which the centricity model 802 is generated.

The example instructions 1200 of FIG. 12 then end and return control to a calling function, such as block 1004 of FIG. 10.

FIG. 13 is a block diagram of an example processor platform 1300 capable of executing the instructions of FIGS. 10, 11, and/or 12 to implement the measurement collector 106, the example centricity modeler 108, the example centricity estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example association table 222, the example object feature learner 224, the example activity searcher 226, the example activity database 228, the example economic data collector 230, the example sales data collector 232, the example sales data repository 234, the example consumer data collector 236, the example consumer data repository 238, the example device location database 240, the example propensity modeler 804, the example capacity modeler 806, the example model combiner 812, the example model tester 814 and/or, more generally, the example market opportunity determiner 100 of FIGS. 1, 2, and/or 8. The processor platform 1300 can be, for example, a server, a personal computer, or any other type of computing device.

The processor platform 1300 of the illustrated example includes a processor 1312. The processor 1312 of the illustrated example is hardware. For example, the processor 1312 can be implemented by one or more integrated circuits, logic circuits, microprocessors or controllers from any desired family or manufacturer.

The example processor 1312 of FIG. 13 implements the example measurement collector 106, the example centricity modeler 108, the example centricity estimator 110, the example aerial image collector 204, the example ground level image collector 206, the example aerial image repository 208, the example ground level image repository 212, the example aerial image analyzer 214, the example ground level image analyzer 216, the example object feature determiner 218, the example object library 220, the example association table 222, the example object feature learner 224, the example activity searcher 226, the example activity database 228, the example economic data collector 230, the example sales data collector 232, the example sales data repository 234, the example consumer data collector 236, the example propensity modeler 804, the example capacity modeler 806, the example model combiner 812, the example model tester 814 and/or, more generally, the example market opportunity determiner 100 of FIGS. 1, 2, and/or 8.

The processor 1312 of the illustrated example includes a local memory 1313 (e.g., a cache). The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), and/or a PCI express interface.

In the illustrated example, one or more input devices 1322 are connected to the interface circuit 1320. The input device(s) 1322 permit(s) a user to enter data and commands into the processor 1312. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1320 of the illustrated example, thus, typically includes a graphics driver card, a graphics driver chip or a graphics driver processor.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.).

The processor platform 1300 of the illustrated example also includes one or more mass storage devices 1328 for storing software and/or data. Examples of such mass storage devices 1328 include floppy disk drives, hard drive disks, compact disk drives, Blu-ray disk drives, RAID systems, and digital versatile disk (DVD) drives. The example mass storage devices 1328 of FIG. 13 may store one or more of the example data sources 112a-112c, the example market opportunity 114 (e.g., one or more heat maps), the example aerial image repository 208, the example ground level image repository 212, the example association table 222, the example activity database 228, the example sales data repository 234, the example consumer data repository 238, the example centricity model 802, the example propensity model 808, and/or the example capacity model 810 of FIGS. 1, 2, and/or 8.

The coded instructions 1332 of FIGS. 10, 11, and/or 12 may be stored in the mass storage device 1328, in the volatile memory 1314, in the non-volatile memory 1316, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method, comprising:
recognizing, using a processor executing a first computer vision technique, a first quantity of a first type of object in a first image of a first area, the first type of object being associated with an item class;
obtaining first measurements of a first set of characteristics for the first area, the first set of characteristics being associated with the item class and including the first quantity of the first type of object recognized using the processor;
determining, using the processor, a first relationship between a first probability of a population in the first area to purchase the item class and the first measurements of the first set of characteristics;
recognizing, using the processor executing at least one of the first computer vision technique or a second computer vision technique, a second quantity of the first type of object in a second image of a second area;
obtaining second measurements of a second set of characteristics for the second area, the second set of characteristics including the second quantity of the first type of object recognized using the processor; and
estimating, using the processor, a second probability of a population of the second area purchasing the item class based on applying the first relationship to the second measurements.
